(19) United States
(12) Patent Application Publication
(10) Pub. No.: US 2013/0265523 A1
(43) Pub. Date: Oct. 10, 2013

(54) Backlight Module and Liquid Crystal Display

(71) Applicants: Zanjia Su, Shenzhen (CN); Kuang-Yao Chang, Shenzhen (CN); Hu He, Shenzhen (CN)

(72) Inventors: Zanjia Su, Shenzhen (CN); Kuang-Yao Chang, Shenzhen (CN); Hu He, Shenzhen (CN)

(73) Assignee: SHENZHEN CHINA STAR OPTOELECTRONICS TECHNOLOGY CO LTD., Guangdong (CN)

(21) Appl. No.: 13/510,602

(22) PCT Filed: Apr. 13, 2012
(86) PCT No.: PCT/CN12/73966

§ 371 Date: May 17, 2012

(30) Foreign Application Priority Data
Apr. 10, 2012 (CN) 201210103419.0

(51) Int. Cl. G02F 1/1335; G02F 1/13357

(52) U.S. Cl. 349/62; 362/602

(57) ABSTRACT

A liquid crystal display (LCD) and a backlight module thereof are proposed. The backlight module includes a light guide plate (LGP), a first prism sheet, and a second prism sheet. The first prism sheet is disposed on the LGP. The second prism sheet is disposed on the first prism sheet. The first and second prism sheets both include a plurality of prisms. The plurality of prisms of the first prism sheet are perpendicular to a longer side of the LGP. The plurality of prisms of the second prism sheet form an angle with the longer side of the LGP, and the angle measures between 15 and 45 degrees. Since the backlight module and the plurality of prisms of the second prism sheet both form the angle between 15 and 45 degrees with the longer side of the LGP, brightness at a frontal viewing angle is enhanced and a viewing angle becomes wider.

### BACKGROUND OF THE INVENTION

1. Field of the Invention

The present invention relates to liquid crystal display (LCD) technology, and more particularly, to a backlight module and an LCD.

2. Description of the Prior Art

LCD technology is well developed and is widely applied in the comtemperary display technology. The LCD uses an electro-optic effect of liquid crystal (LC) and adjusts the strength of light emitted by the backlight module passing through color resistance through transmittance and reflectivity of LC controlled by a circuit. In this way, images having different grayscales and different colors are shown. A backlight module is a key component of the LCD. The backlight module is used as light source of the LCD.

A high-quality LCD should be equipped with a backlight module having uniform brightness, wide viewing angles, perfect uniformity, and good optical characteristics. When the LCD industry tries hard to improve the performance of the backlight module, the LCD industry also makes effort to keep costs of the backlight module unchanged or even to lower the costs. So, it is important to improve the performance of the backlight module based on the original structure of the backlight module on the premise of not increasing costs of the backlight module.

The conventional backlight module often uses a prism sheet to enhance brightness at a frontal viewing angle. When the prism sheet is the topmost layer of the backlight module, best brightness is achieved. However, the size of the prism sheet is almost equivalent to that of the pixel, and the alignment of the prism is parallel to one side of the backlight module. As a result, moire occurs easily and the display effect is affected. To prevent moire from happening, a diffuser sheet is often disposed on the prism sheet in the conventional technology. Referring to FIG. 1, FIG. 1 shows a schematic diagram of the structure of a conventional backlight module. The conventional backlight module comprises a light guide plate (LGP) 10, a first prism sheet 20, a second prism sheet 30, and a diffuser sheet 40. The LGP 10, the first prism sheet 20, the second prism sheet 30, and the diffuser sheet 40 are layered from bottom to top. The diffuser sheet 40 is the topmost layer of the backlight module. The conventional backlight module often uses diffusion provided by the diffuser sheet 40 to prevent moire. However, the diffusion provided by the diffuser sheet 40 decreases the brightness at the frontal viewing angle obviously.

To prevent moire from occurring, an another conventional technology adopts a method of rotating the prism against one side of the backlight module at an angle (3 to 15 degrees). Unfortunately, the conventional technology has a disadvantage. The balance between the brightness at the frontal viewing angle and the viewing angle is not achieved. No better effects are obtained, either.

### SUMMARY OF THE INVENTION

An object of the present invention is to provide a backlight module and an LCD characterized with enhanced brightness at a frontal viewing angle and a wider viewing angle.

According to the present invention, a backlight module for a liquid crystal display (LCD) comprises a light guide plate (LGP), a first prism sheet, a second prism sheet, a light emitting diode (LED) light bar, and a diffuser sheet. The first prism sheet is disposed on the LGP. The second prism sheet is disposed on the first prism sheet. The LED light bar is parallel to a shorter or longer side of the LGP. The diffuser sheet is disposed between the first prism sheet and the LGP. The first prism sheet and the second prism sheet both comprise a plurality of prisms, the plurality of prisms of the first prism sheet are perpendicular to the longer side of the LGP. The plurality of prisms of the second prism sheet form an angle with the longer side of the LGP. The angle measures between 15 and 45 degrees. The second prism sheet is a topmost layer of the backlight module.

In one aspect of the present invention, the angle measures between 20 and 45 degrees.

In another aspect of the present invention, a surface of the LGP near the first prism sheet comprises a plurality of prisms, the plurality of prisms of the LGP form an angle with the longer side of the LGP, and the angle measures between 0 and 90 degrees.

In still another aspect of the present invention, the surface of the LGP near the first prism sheet is flat.

According to the present invention, a backlight module for an LCD comprises an LGP, a first prism sheet, and a second prism sheet. The first prism sheet is disposed on the LGP. The second prism sheet is disposed on the first prism sheet. The first prism sheet and the second prism sheet both comprise a plurality of prisms. The plurality of prisms of the first prism sheet are perpendicular to a longer side of the LGP. The plurality of prisms of the second prism sheet form an angle with the longer side of the LGP. The angle measures between 15 and 45 degrees.

In one aspect of the present invention, the second prism sheet is a topmost layer of the backlight module.

In another aspect of the present invention, the angle measures between 20 and 45 degrees.

In another aspect of the present invention, a surface of the LGP near the first prism sheet comprises a plurality of prisms, the plurality of prisms of the LGP form an angle with the longer side of the LGP, and the angle measures between 0 and 90 degrees.

In another aspect of the present invention, the surface of the LGP near the first prism sheet is flat.

In another aspect of the present invention, the backlight module comprises an LED light bar, and the LED light bar is parallel to a shorter or longer side of the LGP.

In still another aspect of the present invention, the backlight module comprises a diffuser sheet disposed between the first prism sheet and the LGP.

According to the present invention, an LCD comprises an LCD panel and a backlight module. The backlight module comprises an LGP, a first prism sheet, and a second prism sheet. The first prism sheet is disposed on the LGP. The second prism sheet is disposed on the first prism sheet. The first prism sheet and the second prism sheet both comprise a plurality of prisms. The plurality of prisms of the first prism sheet are perpendicular to a longer side of the LGP. The plurality of prisms of the second prism sheet form an angle with the longer side of the LGP. The angle measures between 15 and 45 degrees.

In one aspect of the present invention, the second prism sheet is a topmost layer of the backlight module.

In another aspect of the present invention, the angle measures between 20 and 45 degrees.

In another aspect of the present invention, a surface of the LGP near the first prism sheet comprises a plurality of prisms, the plurality of prisms of the LGP form an angle with the longer side of the LGP, and the angle measures between 0 and 90 degrees.

In another aspect of the present invention, the surface of the LGP near the first prism sheet is flat.

In another aspect of the present invention, the backlight module comprises an LED light bar, and the LED light bar is parallel to a shorter or longer side of the LGP.

In still another aspect of the present invention, the backlight module comprises a diffuser sheet disposed between the first prism sheet and the LGP.

The backlight module and the LCD comprise a second prism sheet and an LGP. A plurality of prisms of the second prism sheet and a longer side of the LGP form an angle measuring between 15 and 45 degrees. According to an experimental result, the backlight module and the LCD of the present invention do enhance the brightness at the frontal viewing angle and offer wider viewing angles without increasing costs.

These and other features, aspects and advantages of the present disclosure will become understood with reference to the following description, appended claims and accompanying figures.

### BRIEF DESCRIPTION OF THE DRAWINGS

FIG. 1 shows a schematic diagram of the structure of a conventional backlight module.

FIG. 2 shows a schematic diagram of the structure of a backlight module according to an embodiment of the present invention.

FIG. 3 showing a schematic diagram of the enlarged structure of the second prism sheet according to the present embodiment of the present invention.

FIG. 4 shows a relationship diagram of brightness at a frontal viewing angle and an angle θ in the backlight module according to the embodiment of the present invention.

FIG. 5 shows a relationship diagram of the viewing angle and the angle θ in the backlight module according to the embodiment of the present invention.

### DETAILED DESCRIPTION OF THE PREFERRED EMBODIMENTS

Hereinafter, exemplary embodiments of the present invention will be described with reference to the accompanying drawings. In the following description, the same elements will be designated by the same reference numerals although they are shown in different drawings. Further, in the following description of the present invention, a detailed description of known functions and configurations incorporated herein will be omitted when it may make the subject matter of the present invention rather unclear.

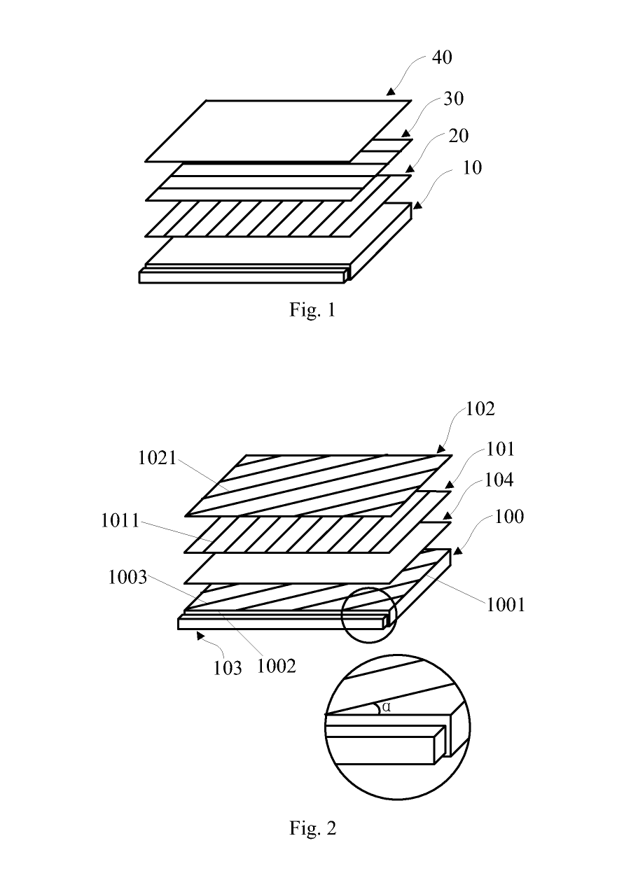

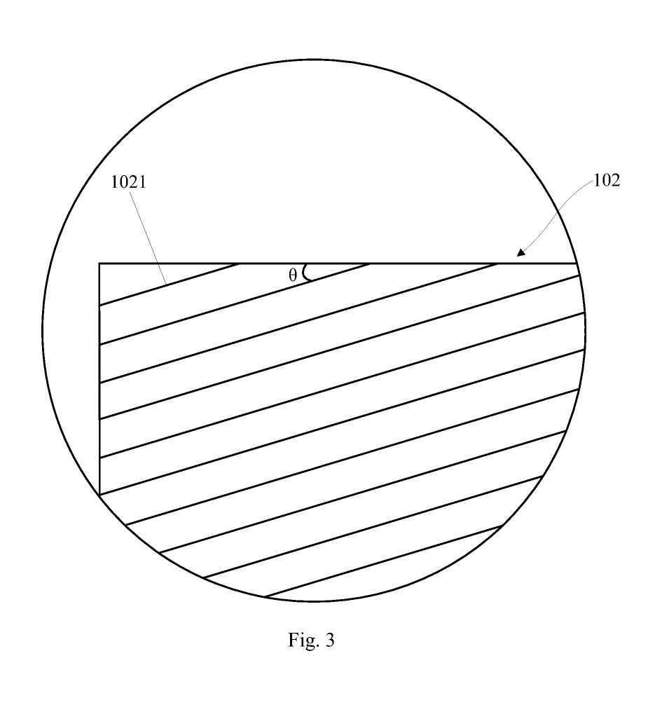

Referring to FIG. 2, FIG. 2 shows a schematic diagram of the structure of a backlight module according to an embodiment of the present invention.

The backlight module comprises an LGP 100, a first prism sheet 101, and a second prism sheet 102. The first prism sheet 101 is disposed on the LGP 100. The second prism sheet 102 is disposed on the first prism sheet 101. The LGP 100 is rectangle-shaped and has a shorter side 1001 and a longer side 1002. The second prism sheet 102 is the topmost layer of the backlight module in the present embodiment. The backlight module of the present invention is used in the LCD. Specifically, the LCD comprises an LCD panel. The LCD panel is disposed on one side of the second prism sheet 102 against the first prism sheet 101.

The first prism sheet 101 comprises a plurality of prisms 1011. The plurality of prisms 1011 are perpendicular to the longer side 1002 of the LGP 100.

The second prism sheet 102 comprises a plurality of prisms 1021. The plurality of prisms 1021 form an angle with the longer side 1002 of the LGP 100, and the angle measures between 15 and 45 degrees. More specifically, refer to FIG. 3 showing a schematic diagram of the enlarged structure of the second prism sheet 102 according to the present embodiment of the present invention. The angle θ between the plurality of prisms 1021 of the second prism sheet 102 and the longer side 1002 of the LGP 100 measures between 15 and 45 degrees. In the present embodiment, the angle θ measures between 15 and 45 degrees. In another preferred embodiment, the plurality of prisms 1021 and the shorter side 1001 of the LGP 100 form an angle measuring between 15 and 45 degrees. The plurality of prisms 1011 is perpendicular to the shorter side 1001.

The backlight module further comprises a light emitting diode (LED) light bar 103 used as a light source of the backlight module. The LED light bar 103 is parallel to a shorter side 1001 or a longer side 1002. In the present embodiment, only one LED light bar 103 is used. In another preferred embodiment, two (or more than two) LED light bars 103 may be used. The two (or more than two) LED light bars 103 are parallel to two arbitrary sides of the LGP 100, respectively.

The backlight module further comprises a diffuser sheet 104 disposed between the first prism sheet 101 and the LGP 100. The diffuser sheet 104 is used for uniformizing light emitted from an emitting surface of the LGP 100.

The second prism sheet 102 on the top surface of the backlight module gathers light emitted from the first prism sheet 101 to a frontal viewing angle to a great extent. Moreover, the plurality of prisms 1021 of the second prism sheet 102 form a specific angle with the longer side 1002 of the LGP 100. As a result, no optical interference (optical moire interference) occurs between the second prism sheet 102 and the LCD panel when the second prism sheet 102 is installed in the LCD. The LCD has wider viewing angles.

The LGP 100 comprises a plurality of prisms 1003 on one surface. The surface is near the first prism sheet 101 and the diffuser sheet 104. The plurality of prisms 1003 form an angle α with the longer side 1002. The angle α measures between 0 and 90 degrees. The plurality of prisms 1003 gather light output offered by the LED light bar 103 at the very beginning. In another preferred embodiment, the surface of the LGP 100 near the first prism sheet 101 is flat.

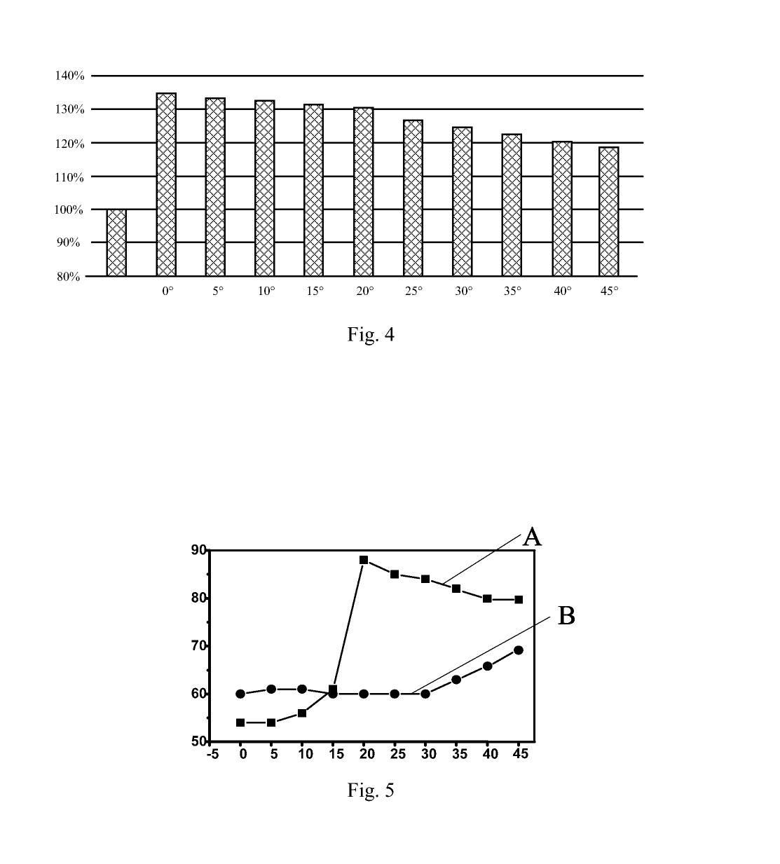

Referring to FIG. 4, FIG. 4 shows a relationship diagram of brightness at a frontal viewing angle and an angle θ in the backlight module according to the embodiment of the present invention.

In FIG. 4, the horizontal axis (x coordinate) indicates the angle θ formed by the plurality of prisms 1021 of the second prism sheet 102 and the longer side 1002 of the LGP 100. The horizontal axis of the bar graph is marked off in degrees. The vertical axis (y coordinate) indicates the gain for brightness at a frontal viewing angle. The vertical axis of the bar graph is marked off in percents. A column represents an angle corresponding to a gain for brightness at a frontal viewing angle. To facilitate comparison, the brightness at the frontal viewing angle of the backlight module in the conventional technology is taken as a reference, that is, the column on the far left in FIG. 4. The far left column is unified and thus defined as 100%.

Referring to FIG. 4, the angle θ of 0°, 5°, 10°, 15°, 20°, 25°, 30°, 35°, 40°, and 45° has an individual gain for the brightness at the frontal viewing angle. The gain for the ten angles θ is 134.6%, 133.3%, 132.2%, 131.4%, 130.1%, 126.5%, 124.6%, 122.4%, 120.5%, and 118.3%, respectively. Compared with the reference, the gain for the brightness at the frontal viewing angle is between 18 percents and 30 percents when the angle θ measures between 20 and 45 degrees. Obviously, the brightness at the frontal viewing angle is enhanced.

Referring to FIG. 5, FIG. 5 shows a relationship diagram of the viewing angle and the angle θ in the backlight module according to the embodiment of the present invention.

In FIG. 5, the horizontal axis (x coordinate) indicates the angle θ formed by the plurality of prisms 1021 of the second prism sheet 102 and the longer side 1002 of the LGP 100. The horizontal axis of the bar graph is marked off in degrees. The vertical axis (y coordinate) indicates the viewing angle. The vertical axis of the bar graph is marked off in degrees. A curve A indicates horizontal viewing angles. A curve B indicates vertical viewing angles. The horizontal viewing angle is an angle in a horizontal alignment formed when the value of brightness along a horizontal dimension is decreased to one third of the value of the brightness at the frontal viewing angle. The vertical viewing angle is an angle in a vertical alignment formed when the value of brightness along a vertical dimension is decreased to one third of the value of the brightness at the frontal viewing angle.

As shown in FIG. 5, the horizontal viewing angles keep above 60 degrees when the angle θ measures between 15 and 45 degrees; the vertical viewing angles keep around 60 degrees when the angle θ measures between 0 and 30 degrees; the vertical viewing angles keep above 60 degrees when the angle θ measures between 30 and 45 degrees. That is, wider horizontal viewing angles and wider vertical viewing angles are achieved when the angle θ measures between 15 and 45 degrees. Moreover, the horizontal viewing angles and the vertical viewing angles are relative to brightness according to the definition of the horizontal viewing angles and the vertical viewing angles. In other words, the brightness at the frontal viewing angle is enhanced whenever the scope of the horizontal viewing angles and the vertical viewing angles increases It is notified that the horizontal viewing angles increase rapidly when the angle θ measures from 15 degrees to 20 degrees. Compared with the angle θ measuring 41 degrees, better horizontal viewing angles are offered when the angle θ measures between 40 and 45 degrees. Thus, the LCD equipped with the backlight module of the present invention have a wider viewing angle and a wider frontal viewing angle. As for the viewing angles, the backlight module of the present invention can meet the requirement of the LCD industry. In addition, the structure of the backlight module of the present invention is the same as that of the conventional technology, so costs are unchanged.

By adopting the above-mentioned method, the plurality of prisms 1021 of the second prism sheet 102 form an angle θ with the longer side 1002 of the LGP 100, and the angle θ measures between 15 and 45 degrees. In accordance with the method provided by the present invention, the brightness at the frontal viewing angle is enhanced and the viewing angle becomes wider without increasing costs.

While the present invention has been described in connection with what is considered the most practical and preferred embodiments, it is understood that this invention is not limited to the disclosed embodiments but is intended to cover various arrangements made without departing from the scope of the broadest interpretation of the appended claims.

What is claimed is:

1. A backlight module for a liquid crystal display (LCD), comprising:
a light guide plate (LGP);
a first prism sheet, disposed on the LGP;
a second prism sheet, disposed on the first prism sheet;
a light emitting diode (LED) light bar, being parallel to a shorter or longer side of the LGP;
a diffuser sheet, disposed between the first prism sheet and the LGP;
wherein the first prism sheet and the second prism sheet both comprise a plurality of prisms, the plurality of prisms of the first prism sheet are perpendicular to the longer side of the LGP, the plurality of prisms of the second prism sheet form an angle with the longer side of the LGP, the angle measures between 15 and 45 degrees, and the second prism sheet is a topmost layer of the backlight module.

2. The backlight module as claimed in claim 1, wherein the angle measures between 20 and 45 degrees.

3. The backlight module as claimed in claim 1, wherein a surface of the LGP near the first prism sheet comprises a plurality of prisms, the plurality of prisms of the LGP form an angle with the longer side of the LGP, and the angle measures between 0 and 90 degrees.

4. The backlight module as claimed in claim 1, wherein the surface of the LGP near the first prism sheet is flat.

5. A backlight module for an LCD, comprising:
an LGP;
a first prism sheet, disposed on the LGP;
a second prism sheet, disposed on the first prism sheet;
wherein the first prism sheet and the second prism sheet both comprise a plurality of prisms, the plurality of prisms of the first prism sheet are perpendicular to a longer side of the LGP, the plurality of prisms of the second prism sheet form an angle with the longer side of the LGP, and the angle measures between 15 and 45 degrees.

6. The backlight module as claimed in claim 5, wherein the second prism sheet is a topmost layer of the backlight module.

7. The backlight module as claimed in claim 5, wherein the angle measures between 20 and 45 degrees.

8. The backlight module as claimed in claim 5, wherein a surface of the LGP near the first prism sheet comprises a plurality of prisms, the plurality of prisms of the LGP form an angle with the longer side of the LGP, and the angle measures between 0 and 90 degrees.

9. The backlight module as claimed in claim 5, wherein the surface of the LGP near the first prism sheet is flat.

10. The backlight module as claimed in claim 5, wherein the backlight module comprises an LED light bar, and the LED light bar is parallel to a shorter or longer side of the LGP.

11. The backlight module as claimed in claim 5, wherein the backlight module comprises a diffuser sheet disposed between the first prism sheet and the LGP.

12. An LCD, comprising an LCD panel and a backlight module, the backlight module comprising:
an LGP;
a first prism sheet, disposed on the LGP;
a second prism sheet, disposed on the first prism sheet;
wherein the first prism sheet and the second prism sheet both comprise a plurality of prisms, the plurality of prisms of the first prism sheet are perpendicular to a longer side of the LGP, the plurality of prisms of the second prism sheet form an angle with the longer side of the LGP, the angle measures between 15 and 45 degrees, and the LCD panel is disposed on one side of the second prism sheet against the first prism sheet.

13. The LCD as claimed in claim 12, wherein the second prism sheet is a topmost layer of the backlight module.

14. The LCD as claimed in claim 12, wherein the angle measures between 20 and 45 degrees.

15. The LCD as claimed in claim 12, wherein a surface of the LGP near the first prism sheet comprises a plurality of prisms, the plurality of prisms of the LGP form an angle with the longer side of the LGP, and the angle measures between 0 and 90 degrees.

16. The LCD as claimed in claim 12, wherein the surface of the LGP near the first prism sheet is flat.

17. The LCD as claimed in claim 12, wherein the backlight module comprises an LED light bar, and the LED light bar is parallel to a shorter or longer side of the LGP.

18. The LCD as claimed in claim 12, wherein the backlight module comprises a diffuser sheet disposed between the first prism sheet and the LGP.
